(19) United States
(12) Patent Application Publication
(10) Pub. No.: US 2015/0364146 A1
(43) Pub. Date: Dec. 17, 2015

(54) Method for Providing Visual Feedback for Vowel Quality

(71) Applicants: David Larsen, Orem, UT (US); Dan Smith, Orem, UT (US)

(72) Inventors: David Larsen, Orem, UT (US); Dan Smith, Orem, UT (US)

(21) Appl. No.: 14/302,083

(22) Filed: Jun. 11, 2014

(51) Int. Cl. G10L 21/10

(52) U.S. Cl. CPC G10L 21/10

(57) ABSTRACT

A method for obtaining visual feedback for vowel quality is disclosed. By filtering and decomposing audio signals in formants, one or more software modules and/or applications may determine the type of phoneme in an audio signal that corresponds to a vowel. First and second formants may be measured in their frequencies; subsequently frequencies values of first formant and second formant may be assigned as X and Y coordinates, respectively. These (X,Y) coordinates may be used for graphing points and trajectories of the points in a Cartesian coordinate system while the user is pronouncing a vowel. Thus, graphic feedback for vowel pronunciation may be obtained.

### CROSS-REFERENCE TO RELATED APPLICATIONS

N/A

### BACKGROUND

1. Field of the Disclosure

The present disclosure relates generally to methods and systems for providing visual feedback for vowel quality, more specifically to a method that depicts specific phonemes in a graphic feedback system.

2. Background Information

Correct pronunciation of vowels is closely related with speech disorders and/or speech accent. In order to achieve a correct pronunciation, therapists and trainers listen to patients and/or students pronunciations several times for determining what is wrong in their pronunciation. In addition, patients and students have to speak several times and may invest hours of practice in front of the therapist and/or trainer for achieving the desired pronunciation. Additionally, this method is not 100% effective because patients and students tend to stop the treatment due to slow advance in their progress. Furthermore, the foregoing method is expensive because of the need for paying professional therapists and trainers.

Thus, a need exists for a method for obtaining a quicker and cheaper feedback for training/practicing vowel pronunciation.

### SUMMARY

A method for providing visual feedback for vowel pronunciation is disclosed. The method for providing visual feedback may be employed by one or more software modules and/or applications, which may be executed in one or more computing devices such as, computers, laptop computers, tablets, smartphones, and the like. One or more algorithms and/or set of instructions may execute a workflow for determining the vowel pronounced by a user and subsequently may provide a graphic feedback of the quality of the pronunciation.

According to various embodiments, a method for providing vowel feedback quality may obtain an audio signal and then may filter it. Filtering of audio signal may reduce noise, interference, and the like. Filtering may provide a smoother and clearer audio signal, which may be easily processed for decomposing formants present on the audio signal.

According to an embodiment, formant decomposed from an audio signal may provide frequencies values that may be used for graphing visual feedback using a Cartesian coordinates system. One or more software modules and/or applications may depict vowel pronunciation by depicting a point located in specific areas assigned to specific vowels.

The method for providing visual feedback for vowels disclosed herein may provide self-training capability to people that may possess speech disorders and/or want to improve their accent in a particular language. By using the method described herein, patients and/or students may obtain immediate feedback of their performance at lower costs than the current methods.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a flowchart describing the workflow operation of a method for providing visual feedback of vowels quality.

FIG. 2 depicts raw audio signals and filtered audio signals used for determining vowel quality.

FIG. 3 is a group of waveforms corresponding to an audio signal containing formants and the three first formant waveforms contained in that audio signal.

FIG. 4 is a graphic feedback system that employs the Cartesian coordinate system for graphing vowel quality pronunciation.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Audio Signal” refers to one or more waveforms created by a user that may be detected by one or more sensors.

“Phoneme” refers to the smallest unit of sound in a given language that carries meaning and that can change the meaning of a word.

“Formant” refers to distinguishable frequency components of analog speech signals that make up intelligible speech.

### Description of the Drawings

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

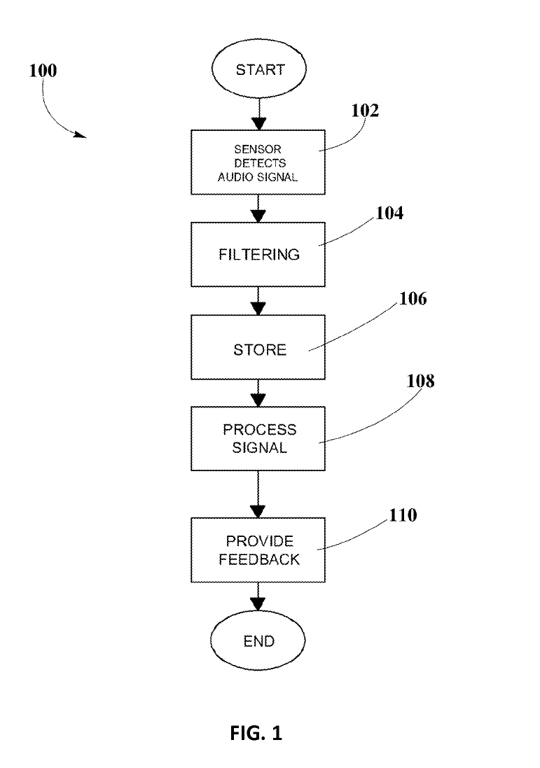

FIG. 1 depicts a flowchart describing a method for visual feedback for vowel quality 100, where the method may be employed by one or more software modules including one or more algorithms and/or one or more set of instructions. Method for visual feedback for vowel quality 100 may be executed in one or more computing devices, including tablets, smartphones, laptop computers, desktop computers, and the like.

Method for visual feedback for vowel quality 100 may start when a software module and/or application installed on a computing device detects an audio signal from the user in step 102. The audio signal may be detected by one or more sensors, including microphones and pressure transducers, among others.

The one or more sensors may then capture a user's speech as an audio signal, where the user has pronounced a vowel. In one or more embodiments, the pronounced vowel may be any phonetic vowel present in any language.

Subsequently, in step 104, the software module and/or application may filter the audio signal. By filtering the audio signal, undesirable characteristics of the audio signal may be removed. Such characteristics may include noise, echo, over modulation, interference, and saturation, among others. Thus, the software module and/or application may produce a smooth and clear audio signal from a distorted audio signal. Hence, filtering may increase the accuracy of audio signal analyses due to clearer formants in the audio signal. Software modules and/or applications may additionally use a plurality of audio filtering techniques, such as audio modulation, signal boost, frequency filtering, decibel discrimination, and the like.

After filtering the audio signal, in step 106, one or more software modules and/or applications may store the filtered audio signal in temporary and/or permanent memory, including Random access memory (RAM), Hard disk drives (HDD), Flash memory, and the like. Audio signals may be stored in order to avoid loss and/or corruption of the audio signal.

Subsequently, in step 108, one or more software modules and/or applications may process the stored audio signal. The audio signal may be processed in order to determine the exact phoneme pronounced by the user, where the phoneme may include one or more formants. Formants are the key factor for identifying specific phonemes and hence specific vowel pronunciation. Software modules and/or applications may employ a variety of techniques for extracting and measuring formants from the stored audio signal. Typically, the method employed for extracting formants may include measuring the frequency and wavelength for a subsequent identification of formants.

Finally, by identifying the formants with their respective values of frequencies and/or wavelengths, the software module and/or application may provide graphic feedback to the user in step 110. Graphic feedback may include one or more points depicted on a screen, a moving point, bars status, messages, and the like. In addition, software modules and/or applications may provide audio feedback, which may include a sample of the desired pronunciation. Therefore, the user may use this sample for emulating and achieving the desired pronunciation.

According to an embodiment, graphic feedback may include location of a point, signal and/or figure on a specific position in a display of one or more computing devices, where said position may have a specific vowel pronunciation associated with it. The software module and/or application may employ a Cartesian coordinate system for graphing such points, signals, and/or figures. By using the values of the first and second formant as X and Y coordinates, respectively, software modules and/or applications may locate the points, signals and/or figures on the Cartesian coordinate system and may be displayed on the screen of the computing device. In addition, points, signals and/or figures may depict a trajectory while changing position on the screen. Thus, the user may know where and how the pronunciation starts and finishes, allowing understanding of the vowel pronunciation quality.

### Filtering Process

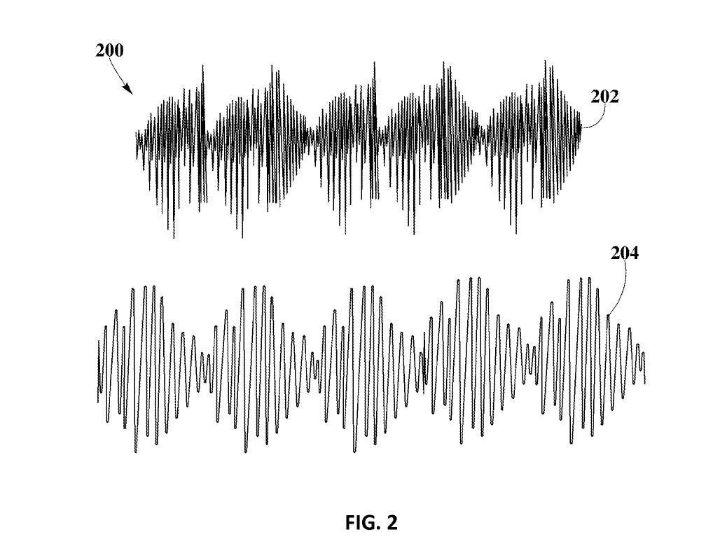

FIG. 2 depicts filtering process 200, including a raw audio signal 202 and filtered signal 204. Raw audio signal 202 may be the immediate recorded sample from one or more users, and may include environment noise, echo, over modulation, interference, and saturation, among others. These and other characteristics may negatively affect a subsequent signal processing by delaying the process, providing false values, and the like.

In order to reduce the above mentioned characteristics, one or more software modules and/or applications may filter raw audio signal 202 by modulating peaks and troughs. Modulation by the one or more software modules and/or applications may reduce sharpness of peaks and troughs and/or may eliminate minor peaks and troughs for producing a smoother audio signal. In addition, the one or more software modules and/or applications may increase the intensity of the signal by boosting raw audio signal 202 and/or specific peaks and troughs. In order to reduce environment noise, frequency filtering may be used. Frequency filtering may discriminate frequencies associated with different noises, including cars, music, pets, people speaking at certain distance, and the like. Decibel discrimination may be used as complementary technique for frequency filtering.

In consequence, by filtering raw audio signal 202, a filtered signal 204 may be obtained. Filtered signal 204 may include smoother and clearer peaks and troughs allowing an accurate and fast recognition of formants present in the filtered signal 204.

### Processing the Signal

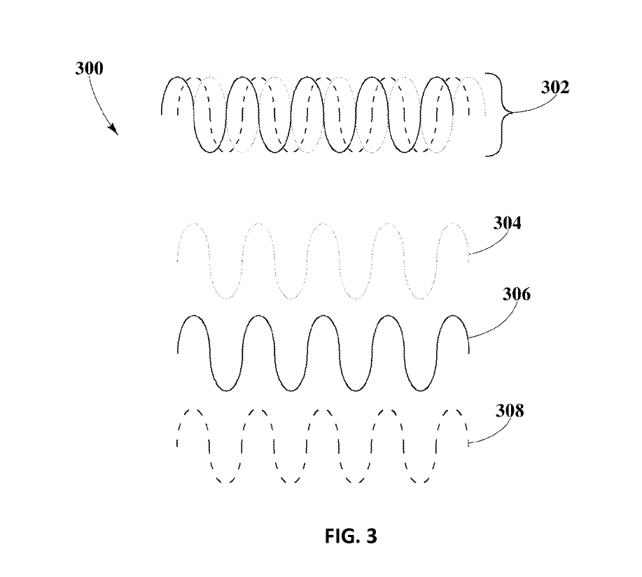

FIG. 3 depicts processed audio signals 300, including an processed audio signal 302, which may include various formants which may determine one or more phonemes are present in the processed audio signal 302. Formants may include waveforms in various frequencies, and software modules and/or applications may typically use first formant 304 and second formant 306 for determining the phoneme. However, third formant 308 and other formants may be used for increasing accuracy when determining the one or more phonemes.

Software modules and/or applications may examine a filtered audio signal for producing a processed audio signal 302. This process may be achieved by measuring frequencies of different waveforms embedded in the filtered audio signal. Subsequently, software modules and/or applications may decompose processed audio signal 302 into the formants included in such signals. For decomposing the processed audio signal 302 into first formant 304, second formant 306 and third formant 308, software modules and/or applications may take the previously measured frequencies of the waveforms in processed audio signal 302, and may categorize which frequency corresponds to a specific range of formant.

### Graphic Feedback

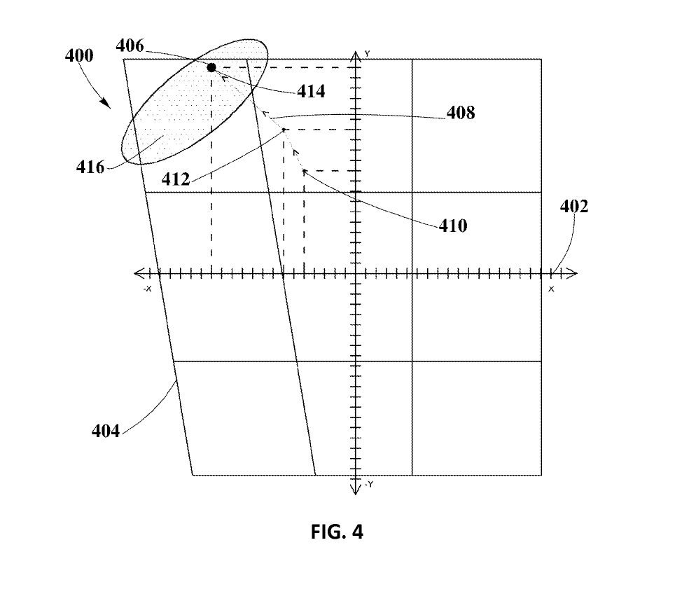

FIG. 4 Depicts a graphic feedback system 400 including Cartesian coordinate system 402 superposed on a graphic representation of mouth resonance cavity 404. According to an embodiment, graphic feedback may include the location of a point 406 on a specific position in a display of one or more computing devices, where said position may have a specific vowel pronunciation associated with it. In some embodiments, point 406 may instead be a suitable signal, figure, or other suitable graphic representation. One or more software modules and/or applications may employ a Cartesian coordinate system for graphing a point 406, signal, and/or figure.

By using the frequency values of the first and second formant as X and Y coordinates, respectively, software modules and/or applications may locate point 406 on the Cartesian coordinate system; which may be then be displayed on the screen of the computing device. In addition, point 406 may depict a trajectory 408 while changing position on the screen. Thus, the user may know where and how the pronunciation starts and finishes. For example, point 406 may be at a first location 410 when the user starts the pronunciation of a vowel and, as the user continues the to pronounce the vowel, point 406 is changed to second location 412, and finally the point 406 reaches final location 414 where the software modules and/or applications previously assigned as the place for the specific vowel pronunciation. While the point 406 moves through the graphic feedback system 400, trajectory 408 may be shown, indicating the beginning and the end of the pronunciation.

The employment of graphic representation of the mouth resonance cavity 404 may be intended to provide a full visualization of the pronunciation process performed in the mouth. By using the graphic representation of the mouth resonance cavity 404, users may easily understand where the sound is produced.

Furthermore, graphic feedback system 400 may employ highlighted areas 416, which may show the range for a specific vowel pronunciation. For example, if point 406 appears between the boundaries of a highlighted area 416, it may mean that the pronunciation corresponds to an average pronunciation of the vowel.

While various aspects and embodiments have been disclosed, other aspects and embodiments are contemplated. The various aspects and embodiments disclosed are for purposes of illustration and are not intended to be limiting, with the true scope and spirit being indicated by the following claims.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined here may be applied to other embodiments without departing from the spirit or scope of the invention. Thus, the present invention is not intended to be limited to the embodiments shown here but is to be accorded the widest scope consistent with the following claims and the principles and novel features disclosed here.

What is claimed is:

1. A method of providing visual feedback for speech therapy, comprising:
receiving at least one audio signal;
measuring a frequency and a wavelength of the at least one audio signal;
identifying at least one formant indicative of the measured frequency and the measured wavelength of at least a portion of the at least one audio signal; and
providing at least one visual indication in accordance with the at least one formant.

2. The method of claim 1, wherein the visual indication is presented on a display device, and is selected from the group consisting of one or more points, a moving point, a bar, a message, and combinations thereof.

3. The method of claim 1, further comprising:
filtering the at least one audio signal.

4. The method of claim 3, wherein the filtering removes from the at least one audio signal one selected from the group consisting of environmental noise, echo, over modulation, interference, saturation, or combinations thereof.

5. The method of clam 1, wherein the at least one audio signal comprises human speech.

6. The method of clam 1, wherein the at least one audio signal comprises vowel pronunciation

7. A method of providing visual feedback for speech therapy, comprising:
receiving at least one audio signal;
measuring a frequency and a wavelength of the at least one audio signal;
indentifying at least one phoneme indicative of a first formant and a second formant, wherein each formant is indicative of the measured frequency and the measured wavelength of at least a portion of the at least one audio signal; and
providing at least one visual indication in accordance with the at least one phoneme.

8. The method of claim 7, further comprising:
identifying a third formant where the identified phoneme is compared to the third formant.

9. The method of claim 7, wherein the visual indication is presented on a display device, and is selected from the group consisting of one or more points, a moving point, a bar, a message, and combinations thereof.

10. The method of claim 7, wherein the at least one audio signal comprises human speech.

11. The method of clam 7, wherein the at least one audio signal comprises vowel pronunciation

12. The method of claim 9, further comprising:
filtering the at least one audio signal.

13. The method of claim 12, wherein the filtering removes from the at least one audio signal one selected from the group consisting of environmental noise, echo, over modulation, interference, saturation, or combinations thereof.

14. A method of providing visual feedback for speech therapy, comprising:
receiving at least one audio signal;
measuring a plurality of frequency values of the at least one audio signal;
identifying a plurality of formants indicative of the measured frequency values of at least a portion of the at least one audio signal; and
providing a visual indication in accordance with the plurality of formants.

15. The method of claim 14, wherein the visual indication comprises at least two Cartesian points representative of ones of the plurality of formants.

16. The method of claim 14, wherein the visual indication comprises line between at least to two Cartesian points representative of ones of the plurality of formants.

17. The method of claim 16, wherein the line is non-linear.

18. The method of claim 14, wherein the visual indication comprises at least one bounded area inclusive of a portion of the at least two Cartesian points representative of ones of the plurality of formants.

19. The method of clam 14, wherein the at least one audio signal comprises human speech.

20. The method of clam 14, wherein the at least one audio signal comprises vowel pronunciation.
